(19) United States
(12) Patent Application Publication
(10) Pub. No.: US 2014/0242998 A1
(43) Pub. Date: Aug. 28, 2014

(54) TERMINAL AND BASE STATION IN WIRELESS COMMUNICATION SYSTEM WITH MULTIPLE HIERARCHICAL CELLS AND COMMUNICATION METHOD OF TERMINAL IN WIRELESS COMMUNICATION SYSTEM WITH MULTIPLE HIERARCHICAL CELLS

(71) Applicant: Electronics and Telecommunications Research Institute, Daejeon (KR)

(72) Inventors: Don Sung OH, Daejeon (KR); Min Ho CHEONG, Daejeon (KR); Sok Kyu LEE, Daejeon (KR); Seung Chan BANG, Daejeon (KR)

(73) Assignee: Electronics and Telecommunications Research Institute, Daejeon (KR)

(21) Appl. No.: 14/191,313

(22) Filed: Feb. 26, 2014

(30) Foreign Application Priority Data
Feb. 28, 2013 (KR) 10-2013-0022036

(51) Int. Cl. H04W 36/26

(52) U.S. Cl. CPC H04W 36/26
USPC 455/444

(57) ABSTRACT

Disclosed are handover and connection of a terminal and control of connection of a terminal by a base station in a communication environment including a plurality of communication cells having different ranges of communication coverage. According to an exemplary embodiment, a terminal of a wireless communication system including a plurality of hierarchical cells determines whether the terminal accesses a microcell in a macrocell as the terminal moves based on whether a control signal transmitted from a micro-base station managing the microcell is detected in a communication environment including a plurality of hierarchical cells divided according to communication coverage, determines whether the terminal connects to the microcell based on a connection criteria for the microcell, and connects to the microcell when the connection criteria for the microcell are satisfied and conducts communications using the macrocell when the connection criteria for the microcell are not satisfied.

### CROSS-REFERENCE TO RELATED APPLICATION

This application claims the priority benefit of Korean Patent Application No. 10-2013-0022036, filed on Feb. 28, 2013, in the Korean Intellectual Property Office, the disclosure of which is incorporated herein by reference.

### BACKGROUND

1. Field of the Invention

The present invention relates to handover and connection of a terminal in a communication environment including a plurality of communication cells having different ranges of communication coverage and control of connection of a terminal by a base station.

2. Description of the Related Art

In downtown areas or crowed regions with traffic, mobile terminals may not be provided with services at satisfactory data rate with current macrocell-centered mobile communication technology. Thus, a method using a multiple hierarchical cell structure which includes both a microcell and a macrocell is attempted to solve communication problems in areas congested with traffic.

Mobile terminals may receive data services using Long Term Evolution (LTE) and WiFi technologies. Here, when a large number of terminals attempt to receive data services at the same time, the terminals may not receive data services at desired rate.

In such an environment, the 3rd Generation Partnership Project (3GPP) try to use a wider frequency bandwidth through standardization of LTE-adv and to employ carrier aggregation and multiple-input and multiple-output (MIMO) technologies so as to provide data services at user desired rate. However, despite use of these technologies, if a greater amount of traffic is required in the future, a larger number of microcells will be needed for use.

In a mobile communication environment where a microcell and a macrocell are present together, effective mobility management is necessary. That is, when a mobile terminal enters a hot spot zone with heavy traffic in a macro cell environment, the mobile terminal connects to a microcell to obtain desired traffic capacity. However, a service area of one microcell may be very narrow. Thus, a mobile terminal moving at fast speed in some extent involves frequent handover, and thus a macrocell is effective for such mobile terminal instead of a microcell.

A micro-base station may need to acquire information on moving speed of each terminal accommodated therein. However, some terminals do not use the Global Positioning System (GPS) in view of power consumption, and thus speed information on the terminals may be obtained.

Thus, it is quite difficult for the micro-base station to manage connection of each terminal to a microcell or macrocell based on moving speed of each terminal

### SUMMARY

An aspect of the present invention provides a method of determining which of a macrocell and a microcell cell one terminal selects when the terminal conducts handover of a cell or connection to a new cell as the terminal moves in an environment including cells with different ranges of communication coverage.

In detail, there is provided a method of preferentially selecting a macrocell when a terminal connects the macrocell or a microcell a predetermined number of times or more for a set period of time and of preferentially selecting a microcell when the terminal connects to the macrocell or microcell less than the predetermined number of times.

Further, there is provided a method of preferentially selecting a macrocell when connection retention time of a terminal in a recently connected cell is shorter than a preset period of time and of preferentially selecting a microcell when the connection retention time is longer than the preset period of time.

According to an aspect of the present invention, there is provided a terminal of a wireless communication system including a plurality of hierarchical cells, the terminal including an access detection unit to determine whether the terminal accesses a microcell in a macrocell as the terminal moves based on whether a control signal transmitted from a micro-base station managing the microcell is detected in a communication environment including a plurality of hierarchical cells divided according to communication coverage, a controller to determine whether the terminal connects to the microcell based on a connection criteria for the microcell, and a communication unit to connect to the microcell when the connection criteria for the microcell are satisfied and to conduct communications using the macrocell when the connection criteria for the microcell are not satisfied.

The connection criteria for the microcell may include at least one of whether the terminal attempts to connect to a predetermined number of microcells or fewer for a set period of time and whether the terminal maintains connection to a previous microcell to the currently accessed microcell for a predetermined period of time or longer.

The connection criteria for the microcell may include at least one of whether the terminal attempts to connect to a predetermined number of hierarchical cells or fewer for a set period of time and whether the terminal maintains connection to a previous hierarchical cell to the currently accessed microcell for a predetermined period of time or longer.

The communication unit may receive information on the connection criteria for the microcell from the micro-base station.

The communication unit may conduct connection or handover to the macrocell when the connection criteria for the microcell are not satisfied.

The terminal may further include a communication controller to control communications with the micro-base station when connection to the microcell is determined, and to control communications with a macro-base station managing the macrocell when one of connection to the macrocell, maintenance of connection to the macrocell and handover to the macrocell is determined.

The controller may not determine whether the terminal connects to the microcell for a set period of time as long as the terminal does not go out of communication coverage of the macrocell when the terminal does not satisfy the connection criteria for the microcell and thus determines to use the macrocell.

The terminal may further include a calculation unit to calculate a number of hierarchical cells to which the terminal attempts to connect, a number of hierarchical cells to which the terminal is successfully connected, and time for which the terminal maintains connection to each connected hierarchical cell.

The calculation unit may calculate connection time to a hierarchical cell that the terminal fails to connect to as minimum time among preset times even when the terminal fails to connect to the hierarchical cell.

The macrocell and the microcell included in the hierarchical cells may use at least one of different frequency bands, different frequency bandwidths and different types of radio access technology.

According to an aspect of the present invention, there is provided a base station of a wireless communication system including a plurality of hierarchical cells, the base station including an access detection unit to detect that a terminal accesses a microcell by receiving, from the terminal accessing the microcell, a response signal to a control signal transmitted from a micro-base station managing the microcell in a communication environment including a plurality of hierarchical cells divided according to communication coverage, a controller to determine a connection criteria for the microcell based on a traffic state of the microcell, and a communication unit to transmit information on the connection criteria for the microcell to the terminal and to allow connection of a terminal satisfying the connection criteria for the microcell.

The connection criteria for the microcell may include at least one of whether the terminal attempts to connect to a predetermined number of microcells or fewer for a set period of time and whether the terminal maintains connection to a previous microcell to the currently accessed microcell for a predetermined period of time or longer.

The controller may change the predetermine number and the predetermine period of time based on a ratio between a number of terminals accommodated by the microcell and a number of terminals being connected to the microcell.

The controller may determine the predetermine number as a smaller value and the predetermined period of time as a greater value than those before connection loads increase when the connection loads of the microcell increase.

The base station may further include a connection determination unit to determine connection of the terminal to the microcell based on a number of microcells to which the terminal attempts to connect for a set period of time and time for which the terminal maintains connection to a previous microcell to the currently accessed microcell, which are acquired from the terminal accessing the microcell.

The base station may further include an information collection unit to collect information on a number of microcells to which each terminal attempts to connect for a set period of time and time for which each terminal maintains connection to a previous microcell to the currently accessed microcell from the terminals accessing the microcell within a predetermined period of time, and a priority determination unit to determine priority in connection to the microcell with respect to the terminals based on the collected information.

According to an aspect of the present invention, there is provided a communication method of a terminal in a wireless communication system including a plurality of hierarchical cells, the communication method including determining whether the terminal accesses a microcell in a macrocell as the terminal moves based on whether a control signal transmitted from a micro-base station managing the microcell is detected in a communication environment including a plurality of hierarchical cells divided according to communication coverage, determining whether the terminal connects to the microcell based on a connection criteria for the microcell, and connecting to the microcell when the connection criteria for the microcell are satisfied and conducting communications using the macrocell when the connection criteria for the microcell are not satisfied.

The conducting of the communications may receive information on the connection criteria for the microcell from the micro-base station.

The determining may not determine whether the terminal connects to the microcell for a set period of time as long as the terminal does not go out of communication coverage of the macrocell when the terminal does not satisfy the connection criteria for the microcell and thus determines to use the macrocell.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a wireless communication system including a plurality of hierarchical cells according to an exemplary embodiment of the present invention;

FIG. 2 is a block diagram illustrating a terminal in a wireless communication system including a plurality of hierarchical cells according to an exemplary embodiment of the present invention;

FIG. 3 is a block diagram illustrating a base station in a wireless communication system including a plurality of hierarchical cells according to an exemplary embodiment of the present invention;

FIG. 4 is a flowchart illustrating a communication method of a terminal in a wireless communication system including a plurality of hierarchical cells according to an exemplary embodiment of the present invention; and

FIG. 5 is a flowchart illustrating a communication method of a terminal in a wireless communication system including a plurality of hierarchical cells according to another exemplary embodiment of the present invention.

### DETAILED DESCRIPTION

Hereinafter, exemplary embodiments of the present invention will be described in detail with reference to the accompanying drawings.

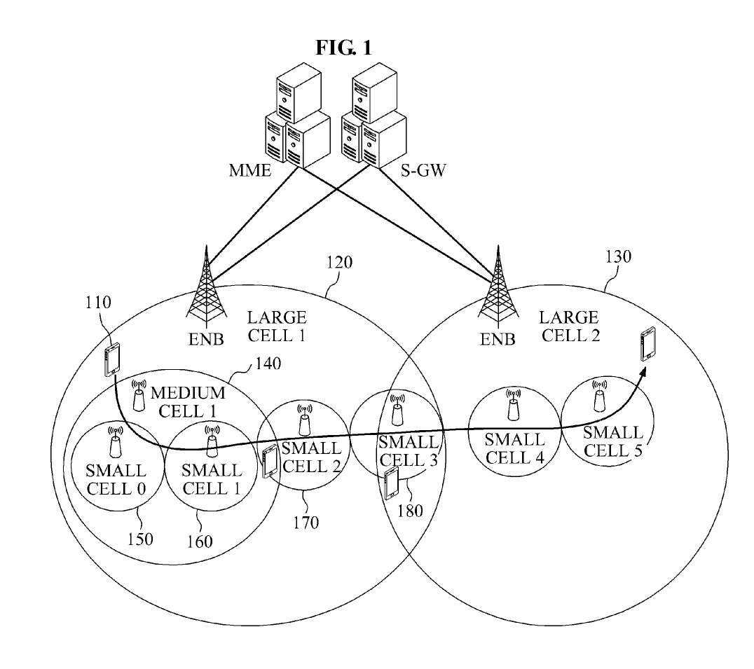

FIG. 1 illustrates a wireless communication system including a plurality of hierarchical cells according to an exemplary embodiment of the present invention.

Referring to FIG. 1, a terminal 110 may conduct desired wireless communications via a base station of a large cell, a medium cell or a small cell. Here, the large cell, the medium cell and the small cell may use the same frequency band or different frequency bands. Further, the cells may use different bandwidths. In addition, different types of radio access technology may be used for a large cell base station, a medium cell base station and a small cell base station. The large cell, the medium cell and the small cell are divided according to a size of communication coverage, wherein the large cell may correspond to a macrocell, while the medium cell and the small cell may correspond to a microcell.

The terminal 110 may pass through a medium cell 1 140, a small cell 0 150, a small cell 1 160, a small cell 2 170, a small cell 3 180 and a large cell 2 130 as the terminal 110 moves conducting communications through a macrocell 1 120. Here, the terminal 110 may perform a handover to a cell that the terminal 110 passes through or maintains a communication state with an already connected cell.

When the terminal 110 enters the medium cell 1 140, the terminal 110 may receive information on connection criteria for the medium cell 1 140 from a base station of the medium cell 1 140. The connection criteria for the medium cell 1 140 may be that the terminal 110 connects to a predetermined number of cells or fewer for a set period of time and that the terminal 110 maintains connection to the large cell 1 120, which the terminal 110 connects to before connecting to the medium cell 1 140, for a predetermined period of time or longer. The terminal 110 may receive the information on the connection criteria for the medium cell 1 140, verify whether the terminal 110 satisfies the connection criteria for the medium cell 1 140, and transmit a connection request signal to the base station of the medium cell 1 140 when the criteria are satisfied. When the terminal 110 does not satisfy the connection criteria for the medium cell 1 140, the terminal 110 may maintain connection to the large cell 1 120.

Alternatively, when the terminal 110 enters the medium cell 1 140, the base station of the medium cell 1 140 may receive information from the terminal 110 to verify whether the terminal 110 satisfies the connection criteria for the medium cell 1 140. When the terminal 110 satisfies the connection criteria for the medium cell 1 140, the base station of the medium cell 1 140 may transmit a signal reporting that connection is possible to the terminal 110. The terminal 110 may receive the signal reporting that connection is possible from the base station of the medium cell 1 140 and then transmit the connection request signal to the base station of the medium cell 1 140.

That is, when the terminal 110 moves, the terminal 110 may determine based on the connection criteria whether connection of the terminal 110 to the medium cell 1 140 is possible or the base station of the medium cell 1 140 may determine based on the connection criteria whether to allow connection of the terminal 110.

Even when the terminal 110 sequentially passes through the small cell 0 150, the small cell 1 160 and the small cell 2 170, the terminal 110 or the base station of each cell may determine whether connection or handover of the terminal 110 to a new microcell is conducted as in a process of determining whether the terminal 110 is connected to the medium cell 1 140.

A base station of the large cell 1 120 and a base station of a large cell 2 130 are controlled in terms of mobility by a mobility management entity (MME) and connected to a network through a serving gateway (SGW). Here, the base station of the medium cell 1 140 and base stations of the small cells may be controlled by either the same MME or different MMEs or may not be controlled in terms of mobility.

In upcoming next-generation mobile communications, the terminal 110 may need an access speed in up to giga bit per second.

In a small cell where such a speed is needed, handover and mobility management of each terminal may not need conducting as meticulously as in a macrocell, that is, a large cell, as in current mobile communications. Meticulous audio or image signal processing for mobile communications is needed just for a large cell and a small cell covering a radio shade area.

In the present invention, a base station managing a small cell may be installed in a downtown area or a crowded area with terminals so as to provide fast data communications to each mobile terminal.

Appropriate access management of a terminal is essential so that a small cell and a large cell properly share or offload traffic. Access management may be carried out by mutual cooperation between a base station and a terminal.

Referring to FIG. 1, communication ranges covered by a plurality of wireless stations may overlap with each other depending on a location of a wireless network base station.

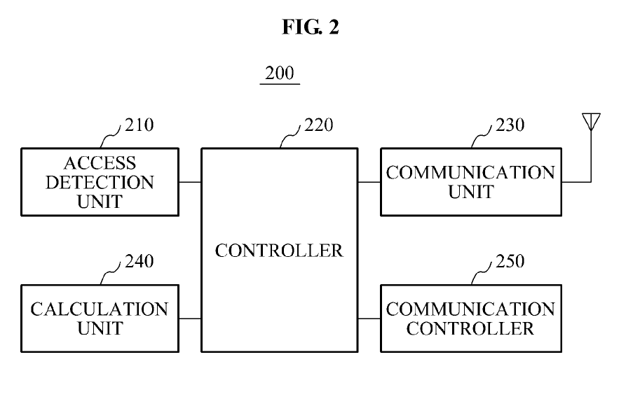

FIG. 2 is a block diagram illustrating a terminal 200 in a wireless communication system including a plurality of hierarchical cells according to an exemplary embodiment of the present invention.

Referring to FIG. 2, the terminal 200 necessarily includes an access detection unit 210, a controller 220 and a communication unit 230, and may additionally include a calculation unit 240 and a communication controller 250 in an alternative embodiment.

In a communication environment including a plurality of hierarchical cells divided according to communication coverage, the terminal 200 may move. The hierarchical cells may include a macrocell and a microcell. Although set up variously according to a communication method, a cell having relatively broad communication coverage may be defiled as a macrocell, while a cell having relatively narrow communication coverage as a microcell. In the present invention, the terminal 200 moves in a communication environment in which the macrocell overlaps with the microcell.

The access detection unit 210 determines whether the terminal 200 enters the microcell in the macrocell as the terminal 200 moves based on whether a control signal transmitted from a micro-base station managing the microcell is detected.

The micro-base station may transmit the control signal. The micro-base station may transmit the control signal so as to verify that the terminal 200 accessing a microcell area enters the microcell area. For instance, the micro-base station may transmit the control signal periodically or at a random time.

The control signal may include, for example, identification information on the micro-base station and information on connection criteria for the microcell.

The controller 220 may determine whether the terminal 210 connects to the microcell based on the connection criteria for the microcell.

The connection criteria for the microcell may include at least one of whether the terminal 200 attempts to connect to a predetermined number Nt of microcells or fewer for a set period of time and whether the terminal 200 maintains connection to a previous microcell to the currently accessed microcell for a predetermine period of time Ts or longer.

Alternatively, the connection criteria for the microcell may include at least one of whether the terminal 200 attempts to connect to a predetermined number Nt of microcells or fewer for a set period of time and whether the terminal 200 stays in a previous microcell to the currently accessed microcell for a predetermine period of time Ts or longer. Here, the previous microcell may be the same as the currently accessed microcell. The terminal 200 may not connect to the currently accessed microcell when the terminal 200 does not satisfy the connection criteria for the currently accessed microcell. When the terminal 200 stays in the same previous microcell as described above even after the predetermined period of time, the controller 220 may determine again whether the terminal 200 in the same location satisfies the connection criteria for the same microcell. Here, when connection fails, the previous microcell used in the connection criteria may refer to the same as the accessed microcell where the terminal 200 currently stays.

Alternatively, the connection criteria for the microcell may include at least one of whether the terminal 200 attempts to connect to a predetermined number Nt of microcells or fewer for a set period of time and whether the terminal 200 maintains connection to a previously connected hierarchical cell to the currently accessed microcell for a predetermine period of time Ts or longer.

The communication unit 230 verifies a connection history of the terminal 200 and connect to the microcell when the terminal 200 satisfies the connection criteria for the microcell.

The communication unit 230 may conduct communications using the macrocell when the connection criteria for the microcell are not satisfied.

The communication unit 230 may receive the information on the connection criteria for the microcell from the micro-base station. The information on the connection criteria for the microcell may be included in the control signal transmitted from the micro-base station or a signal including the information on the connection criteria may be transmitted from the micro-base station, separately from the control signal.

The communication unit 230 may conduct connection or handover to the macrocell when the terminal 200 does not satisfy the connection criteria for the microcell. When the communication unit 230 is connected to the macrocell, the communication unit 230 may maintain a connection state. Alternatively, the communication unit 230 may conduct handover to the macrocell when not connected to the macrocell.

The calculation unit 240 may calculate a number of hierarchical cells to which the terminal 200 attempts to connect, a number of hierarchical cells to which the terminal 200 is successfully connected, and time for which the terminal 200 maintains connection to each connected hierarchical cell. A calculation result by the calculation unit 240 may be stored as a connection history of the terminal 200. The calculation unit 240 may repeat calculation and update details of the connection history whenever the terminal 200 attempts to connect to a new cell.

Even when the terminal 200 fails to connect to a hierarchical cell, the calculation unit 240 may calculate connection time to the hierarchical cell that the terminal 200 fails to connect to as minimum time among preset times. The calculation unit 240 may determine connection time as minimum time even when connection fails. For example, the minimum time may be 0 seconds.

For instance, when the set period of time is five minutes, the predetermined number Nt is three, and the predetermined period of time Ts is two minutes in the connection criteria for the currently accessed microcell, the controller 220 may determine whether the terminal 200 is connected based on a calculation result by the calculation unit 240. The controller 220 determines whether the number of cells to which the terminal 200 attempts to connect is three or fewer for five minutes after the determination point and whether the terminal 200 maintains connection to the previous cell for two minutes or longer, and determines that the terminal 200 is allowed to connect to the currently accessed microcell when such connection criteria are satisfied. That is, the predetermined number Nt for the set period of time and the predetermined period of time Ts for which connection is maintained are the connection criteria for the microcell.

As a result, a terminal 200 that does not satisfy the connection criteria for the microcell maintains communication with the macrocell, whereas only a terminal 200 that satisfies the connection criteria for the microcell is allowed to connect to the microcell thereby achieving appropriate access management of the terminal 200 for properly sharing traffic between the macrocell and the microcell.

The communication controller 250 may control communications with the micro-base station when connection to the microcell is determined, while the communication controller 240 may control communications with a macro-base station managing the macrocell when at least one of connection to the macrocell, maintenance of connection to the macrocell and handover to the macrocell is determined. The communication controller 240 may receive information needed for connection to the microcell from the micro-base station and provides information on the terminal 200, thereby conducting connection to the microcell. The communication controller 250 may also generate and transmit a message about maintenance of connection to the macro-base station via the communication unit 230. Further, the communication controller 250 may receive information needed for handover to the macrocell from the macro-base station and provide the information on the terminal 200, thereby conducting handover to the macrocell.

When the terminal 200 does not satisfy the connection criteria for the microcell and thus determines to use the macrocell, the controller 220 does not determine whether the terminal 200 connects to the microcell for a set period of time as long as the terminal 200 does not go out of communication coverage of the macrocell. The controller 220 does not determine whether the terminal 200 is connected for the set period of time, thereby reducing traffic loads of the microcell. Further, power consumed for determining whether the terminal 200 is connected may be saved to increase hours of use of a battery supplying power to the terminal 200.

The macrocell and the microcell included in the hierarchical cells may use different frequency bands. Further, the macrocell and the microcell included in the hierarchical cells may use different frequency bandwidths. In addition, the macrocell and the microcell included in the hierarchical cells may use different types of radio access technology.

For example, the macrocell is generally given priority in mobile communication services for basic voice and video calls in the terminal 200. The microcell may be mainly used for data communications.

Alternatively, the terminal 200 may simultaneously connect to the macrocell and the microcell. When the terminal 200 moves too fast, the terminal 200 may connect preferentially to the macrocell. Priority in connection is determined based on a number of times each terminal 200 connects to the microcell for a predetermine period of time and time for which each terminal 200 stays in a recently connected cell.

The terminal 200 that moves relatively fast may conduct communications using the macrocell, thereby efficiently distributing traffic among cells.

Connection of the terminal 200 to a cell and traffic management may be stably achieved using degrees of state transitions of the respective macrocell and microcell.

The terminal 200 may provide the number of the times and retention time information to a network.

The terminal 200 connects preferentially to the macrocell when time for which the terminal 200 stays in a previous microcell or macrocell is shorter than required time in the current microcell.

When a number of terminals 200 allowed to connect to each micro-base station exceeds a predetermined count, the micro-base station may restrict access of a terminal 200 that accesses different base stations more times within a predetermine period of time or stays in a very previous cell for a shorter time.

The micro-base station may reduce connection times of terminals 200 to different cells within the predetermined period of time in the connection criteria and increase retention time of terminals 200 in a previous cell with more terminals 200 accommodated therein.

When the terminal 200 chooses to connect to the macrocell, connection of the terminal 200 to a microcell may be restricted for a predetermined period of time.

When failing to normally access a microcell, the terminal 200 may determines retention time in the microcell as minimum time for a predetermined period of time even though not connecting to the microcell.

The terminal 200 belonging to the macrocell does not connect to a microcell for a predetermined period of time, thereby preventing terminals 200 moving fast from frequently attempting to connect the microcell.

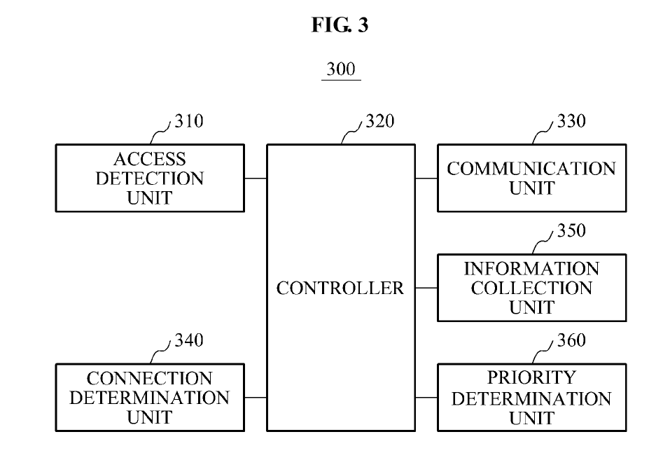

FIG. 3 is a block diagram illustrating a base station 300 in a wireless communication system including a plurality of hierarchical cells according to an exemplary embodiment of the present invention.

Referring to FIG. 3, the base station 300 necessarily includes an access detection unit 310, a controller 320 and a communication unit 330, and may additionally include a connection determination unit 340, an information collection unit 350 and a priority determination unit 360 in an alternative embodiment.

In a communication environment including a plurality of hierarchical cells divided according to communication coverage, a terminal may attempt to connect to a macrocell and a microcell while moving. In the hierarchical cells, the macrocell and the microcell overlap with each other. The base station 300 of FIG. 3 corresponds to a micro-base station managing the microcell.

The access detection unit 310 may detect access of the terminal by receiving, from the terminal accessing the microcell, a response signal to a control signal transmitted from the micro-base station managing the microcell.

The controller 320 may determine a connection criteria for the microcell based on a traffic state of the microcell. For example, the traffic state of the microcell may be determined based on a number of terminal being connected to the microcell, connection loads of the microcell and a management status of the microcell.

The connection criteria for the microcell may include at least one of whether the terminal attempts to connect to a predetermined number of microcells or fewer for a set period of time and whether the terminal maintains connection to a previous microcell to the currently accessed microcell for a predetermine period of time or longer.

The controller 320 may change the predetermine number and the predetermine period of time in the connection criteria based on a ratio between a number of terminals accommodated by the microcell and the number of terminals being connected to the microcell. Generally, since the number of terminals accommodated by the microcell is fixed based on a design of the micro-base station, the controller 320 may reduce the predetermined number and increase the predetermined period of time in the connection criteria with an increasing number of terminals being connected to the microcell.

The controller 320 may also change the set period of time in the connection criteria based on the ratio between the number of terminals accommodated by the microcell and the number of terminals being connected to the microcell.

When the connection loads of the microcell increase, the controller 320 may determine the predetermine number in the connection criteria as a smaller value and the predetermined period of time as a greater value than those before the connection loads increase. That is, the controller 320 may reduce the predetermine number and increase the predetermine period of time.

On the contrary, when the connection loads of the microcell decrease, the controller 320 the predetermine number in the connection criteria as a greater value and the predetermined period of time as a smaller value than those before the connection loads decrease.

The communication unit 330 may transmit information on the connection criteria for the microcell to the terminal and allow connection of a terminal satisfying the connection criteria for the microcell.

In the aforementioned illustration, the terminal receives the information on the connection criteria for the microcell and determines whether to connect to the microcell. In the following illustration, the micro-base station determines whether to conduct connection of the terminal.

The connection determination unit 340 may determine connection of the terminal to a microcell based on a number of microcells to which the terminal attempts to connect for a set period of time and time for which the terminal maintains connection to a previous microcell to a currently accessed microcell, which are acquired from the terminal accessing the microcell.

The information collection unit 350 may collect information on a number of microcells to which each terminal attempts to connect for a set period of time and time for which each terminal maintains connection to a previous microcell to a currently accessed microcell from each terminal accessing the microcell within a predetermined period of time. The information collection unit 350 may request the information to the terminal and collect the information from the terminal.

The priority determination unit 360 may determine priority in connection to the microcell with respect to the terminals based on the information collected by the information collection unit 350.

The micro-base station or macro-base station may periodically collect information corresponding to the connection criteria from the terminals and give access priority to a terminal that moves at slow speed and stays in one cell for a long time among a plurality of terminals.

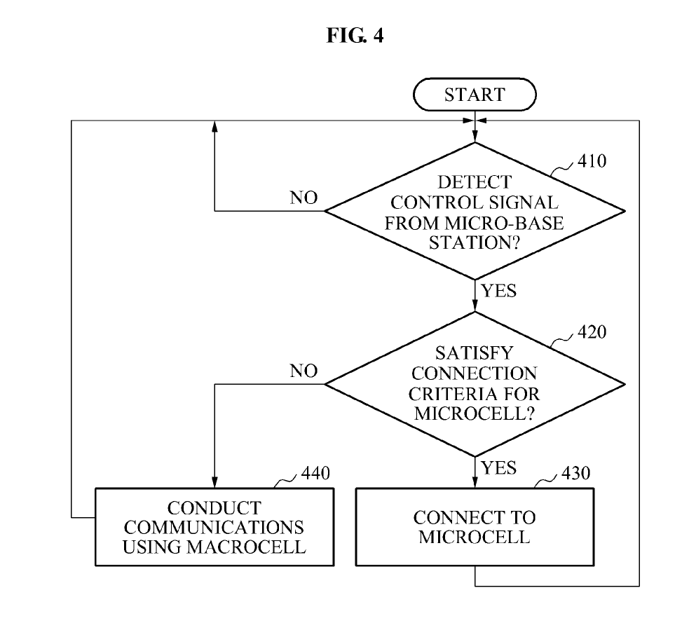

FIG. 4 is a flowchart illustrating a communication method of a terminal in a wireless communication system including a plurality of hierarchical cells according to an exemplary embodiment of the present invention.

In operation 410, the terminal may determine whether the terminal enters a microcell in a macrocell as the terminal moves based on whether a control signal transmitted from a micro-base station managing the microcell is detected in a communication environment including a plurality of hierarchical cells divided according to communication coverage.

In operation 420, the terminal may determine whether the terminal connects to the microcell based on a connection criteria for the microcell.

The connection criteria for the microcell may include at least one of whether the terminal attempts to connect to a predetermined number of microcells or fewer for a set period of time and whether the terminal maintains connection to a previous microcell to the currently accessed microcell for a predetermine period of time or longer.

The terminal receives information on the connection criteria for the microcell from the micro-base station.

When the terminal does not satisfy the connection criteria for the microcell and thus determines to use the macrocell, the terminal does not determine whether the terminal connects to the microcell for a set period of time as long as the terminal does not go out of communication coverage of the macrocell. The terminal may not attempt to connect to the microcell for the set period of time.

In operation 430, the terminal connects to the microcell when the terminal satisfies the connection criteria for the microcell.

In operation 440, the terminal conducts communications using the macrocell when the terminal does not satisfy the connection criteria for the microcell.

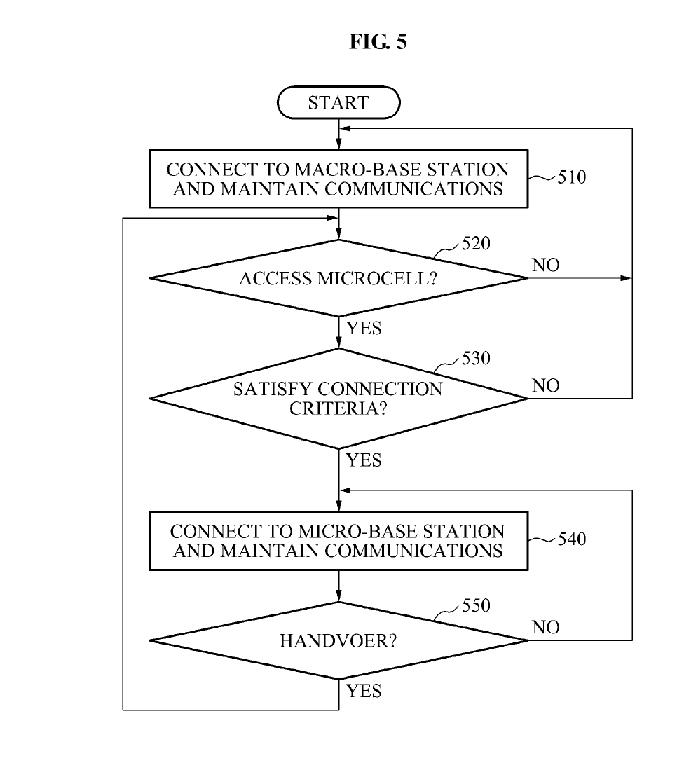

FIG. 5 is a flowchart illustrating a communication method of a terminal in a wireless communication system including a plurality of hierarchical cells according to another exemplary embodiment of the present invention.

In operation 510, the terminal connects to a macro-base station and maintains communications. Here, the macro-base station refers to a base station managing a macrocell.

In operation 520, the terminal verifies whether the terminal enters a microcell, that is, a hot zone, while the terminal moves conducting communications with the macro-base station. For example, when a control signal from a micro-base station is detected, the terminal determines that the terminal enters the hot zone. Here, the hot zone is located within the macrocell managed by the macro-base station that the terminal is connecting to.

When the terminal does not enter the hot zone, the terminal goes back to operation 510 and maintains communications with the connected macro-base station.

In operation 530, when the terminal enters the hot zone, the terminal verifies whether the terminal satisfies a connection criteria for the microcell. The connection criteria for the microcell may include the following two conditions: the terminal passes through a predetermine number Nt of cells or fewer and the terminal stays in a previous cell for a predetermine period of time Ts or longer.

For example, the micro-base station may transmit information on the predetermined number Nt and the predetermined period of time Ts to the terminal via a control signal. The micro-base station may change the predetermined number Nt and the predetermined period of time Ts based on a number of terminals being connected to the microcell and connection loads. When a large number of terminals are connected to the microcell or used traffic loads are high, the micro-base station may relatively reduce the predetermined number Nt and increase the predetermined period of time Ts, thereby restricting accommodation of terminals.

Alternatively, when the micro-base station may not transmit the information on the connection criteria for the microcell, the terminal may receive the information on the predetermined number Nt and the predetermined period of time Ts from the macro-base station that the terminal belongs to and determine whether to connect to the microcell.

In operation 540, the terminal may connect to the microcell when the terminal satisfies the connection criteria for the microcell.

In operation 550, when the terminal maintaining connection to the base station of the microcell needs handover and there is a preferential microcell to which the terminal may connect, the terminal connects to the microcell. When there is no microcell or the terminal does not satisfy the connection criteria for the microcell, the terminal connects to the macrocell.

As described above, an exemplary embodiment provides a method of determining which of a macrocell and a microcell cell one terminal selects when the terminal conducts handover of a cell or connection to a new cell as the terminal moves in an environment including cells with different ranges of communication coverage.

In detail, there is provided a method of preferentially selecting a macrocell when a terminal connects the macrocell or a microcell a predetermined number of times or more for a set period of time and of preferentially selecting a microcell when the terminal connects to the macrocell or microcell less than the predetermined number of times.

Further, there is provided a method of preferentially selecting a macrocell when connection retention time of a terminal in a recently connected cell is shorter than a preset period of time and of preferentially selecting a microcell when the connection retention time is longer than the preset period of time.

The methods according to the above-described exemplary embodiments of the present invention may be recorded in non-transitory computer-readable media including program instructions to implement various operations embodied by a computer. The media may also include, alone or in combination with the program instructions, data files, data structures, and the like. The program instructions recorded in the media may be designed and configured specially for the present invention or be known and available to those skilled in computer software.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention.

Therefore, the scope of the present invention is not limited to the foregoing exemplary embodiments but is defined by the claims and their equivalents.

What is claimed is:

1. A terminal of a wireless communication system comprising a plurality of hierarchical cells, the terminal comprising:
an access detection unit to determine whether the terminal accesses a microcell in a macrocell as the terminal moves based on whether a control signal transmitted from a micro-base station managing the microcell is detected in a communication environment comprising a plurality of hierarchical cells divided according to communication coverage;
a controller to determine whether the terminal connects to the microcell based on a connection criteria for the microcell; and
a communication unit to connect to the microcell when the connection criteria for the microcell are satisfied and to conduct communications using the macrocell when the connection criteria for the microcell are not satisfied.

2. The terminal of claim 1, wherein the connection criteria for the microcell comprises at least one of whether the terminal attempts to connect to a predetermined number of microcells or fewer for a set period of time and whether the terminal maintains connection to a previous microcell to the currently accessed microcell for a predetermined period of time or longer.

3. The terminal of claim 1, wherein the connection criteria for the microcell comprises at least one of whether the terminal attempts to connect to a predetermined number of hierarchical cells or fewer for a set period of time and whether the terminal maintains connection to a previous hierarchical cell to the currently accessed microcell for a predetermined period of time or longer.

4. The terminal of claim 1, wherein the communication unit receives information on the connection criteria for the microcell from the micro-base station.

5. The terminal of claim 1, wherein the communication unit conducts connection or handover to the macrocell when the connection criteria for the microcell are not satisfied.

6. The terminal of claim 1, further comprising a communication controller to control communications with the micro-base station when connection to the microcell is determined, and to control communications with a macro-base station managing the macrocell when one of connection to the macrocell, maintenance of connection to the macrocell and handover to the macrocell is determined.

7. The terminal of claim 1, wherein the controller does not determine whether the terminal connects to the microcell for a set period of time as long as the terminal does not go out of communication coverage of the macrocell when the terminal does not satisfy the connection criteria for the microcell and thus determines to use the macrocell.

8. The terminal of claim 1, further comprising a calculation unit to calculate a number of hierarchical cells to which the terminal attempts to connect, a number of hierarchical cells to which the terminal is successfully connected, and time for which the terminal maintains connection to each connected hierarchical cell.

9. The terminal of claim 8, wherein the calculation unit calculates connection time to a hierarchical cell that the terminal fails to connect to as minimum time among preset times even when the terminal fails to connect to the hierarchical cell.

10. The terminal of claim 1, wherein the macrocell and the microcell comprised in the hierarchical cells use at least one of different frequency bands, different frequency bandwidths and different types of radio access technology.

11. A base station of a wireless communication system comprising a plurality of hierarchical cells, the base station comprising:
an access detection unit to detect that a terminal accesses a microcell by receiving, from the terminal accessing the microcell, a response signal to a control signal transmitted from a micro-base station managing the microcell in a communication environment comprising a plurality of hierarchical cells divided according to communication coverage;
a controller to determine a connection criteria for the microcell based on a traffic state of the microcell; and
a communication unit to transmit information on the connection criteria for the microcell to the terminal and to allow connection of a terminal satisfying the connection criteria for the microcell.

12. The base station of claim 11, wherein the connection criteria for the microcell comprises at least one of whether the terminal attempts to connect to a predetermined number of microcells or fewer for a set period of time and whether the terminal maintains connection to a previous microcell to the currently accessed microcell for a predetermined period of time or longer.

13. The base station of claim 12, wherein the controller changes the predetermine number and the predetermine period of time based on a ratio between a number of terminals accommodated by the microcell and a number of terminals being connected to the microcell.

14. The base station of claim 12, wherein the controller determines the predetermine number as a smaller value and the predetermined period of time as a greater value than those before connection loads increase when the connection loads of the microcell increase.

15. The base station of claim 11, further comprising a connection determination unit to determine connection of the terminal to the microcell based on a number of microcells to which the terminal attempts to connect for a set period of time and time for which the terminal maintains connection to a previous microcell to the currently accessed microcell, which are acquired from the terminal accessing the microcell.

16. The base station of claim 11, further comprising an information collection unit to collect information on a number of microcells to which each terminal attempts to connect for a set period of time and time for which each terminal maintains connection to a previous microcell to the currently accessed microcell from the terminals accessing the microcell within a predetermined period of time; and a priority determination unit to determine priority in connection to the microcell with respect to the terminals based on the collected information.

17. A communication method of a terminal in a wireless communication system comprising a plurality of hierarchical cells, the communication method comprising:
determining whether the terminal accesses a microcell in a macrocell as the terminal moves based on whether a control signal transmitted from a micro-base station managing the microcell is detected in a communication environment comprising a plurality of hierarchical cells divided according to communication coverage;
determining whether the terminal connects to the microcell based on a connection criteria for the microcell; and
connecting to the microcell when the connection criteria for the microcell are satisfied and conducting communications using the macrocell when the connection criteria for the microcell are not satisfied.

18. The communication method of claim 17, wherein the connection criteria for the microcell comprises at least one of whether the terminal attempts to connect to a predetermined number of microcells or fewer for a set period of time and whether the terminal maintains connection to a previous microcell to the currently accessed microcell for a predetermined period of time or longer.

19. The communication method of claim 17, wherein the conducting of the communications receives information on the connection criteria for the microcell from the micro-base station.

20. The communication method of claim 17, wherein the determining does not determine whether the terminal connects to the microcell for a set period of time as long as the terminal does not go out of communication coverage of the macrocell when the terminal does not satisfy the connection criteria for the microcell and thus determines to use the macrocell.
